(19) United States
(12) Patent Application Publication
(10) Pub. No.: US 2004/0078170 A1
(43) Pub. Date: Apr. 22, 2004

(54) System and method for monitoring a structure

(76) Inventor: Don Di Marzio, Northport, NY (US)

Correspondence Address: BAKER BOTTS L.L.P., 2001 ROSS AVENUE, SUITE 600, DALLAS, TX, 75201-2980, US

(21) Appl. No.: 10/274,094

(22) Filed: Oct. 17, 2002

(51) Int. Cl. G06F 11/00; G06F 15/00

(52) U.S. Cl. 702/188

(57) ABSTRACT

According to one embodiment of the invention, a system for monitoring a structure includes a plurality of sensor modules coupled to the structure. Each sensor module includes a sensor operable to sense a characteristic of the structure and a communication device coupled to the sensor. The communication device is operable to receive a signal from the sensor representative of the sensed characteristic and to transmit data representative of the sensed characteristic to one or more neighboring communication devices. The system further includes a central repository operable to receive, from one of the communication devices, the data representative of each sensed characteristic.

### TECHNICAL FIELD OF THE INVENTION

The present invention relates generally to the field of structural monitoring and, more particularly, to a method and system for monitoring a structure, such as an aircraft.

### BACKGROUND OF THE INVENTION

Low-cost, practical structural health monitoring is important to aircraft structural integrity. For example, corrosion damage is a major cause of structural failure, especially for Navy air systems subjected to harsh maritime environments. Fatigue damage is also of particular concern in aircraft and other moving structures subjected to cyclical loads.

Extensive repair and rework of aircraft and other moving structures may result in considerable expense and downtime. For example, the Navy may spend up to $200,000 per aircraft per year on preventative maintenance. A large portion of this cost comes from disassembly of aircraft for programmed inspection. Numerous man-hours are typically needed to inspect structures buried inside an aircraft. Hard-to-access areas of the airframe structure and components pose a particular challenge for inspection.

### SUMMARY OF THE INVENTION

According to one embodiment of the invention, a system for monitoring a structure includes a plurality of sensor modules coupled to the structure. Each sensor module includes a sensor operable to sense a characteristic of the structure and a communication device coupled to the sensor. The communication device is operable to receive a signal from the sensor representative of the sensed characteristic and to transmit data representative of the sensed characteristic to one or more neighboring communication devices. The system further includes a central repository operable to receive, from one of the communication devices, the data representative of each sensed characteristic.

Embodiments of the invention provide a number of technical advantages. Embodiments of the invention may include all, some, or none of these advantages. One technical advantage is that a miniaturized wireless sensor system is easily incorporated into existing aircraft and provides real-time assessment of structural health, such as corrosion, strain, vibration, g-forces, etc. This wireless sensor system is low-cost, low-power, and does not interfere with aircraft avionics. In one embodiment, a combination of wireless data communications modules with state-of the-art corrosion sensors form an autonomous wireless corrosion sensor web (CSW). This CSW is fault tolerant and data packets may always be routed to a central repository. Local module-to-module radio frequency (RF) transmission requires low power and greatly reduces or eliminates RF shielding problems found in enclosed and difficult to access airframe structures. In one embodiment, the CSW may provide real time, incipient corrosion detection to allow rapid, pre-emptive corrective actions to be accomplished at minimal cost and little disruption to both the user and maintainer of aircraft. An autonomous system that may detect corrosive environments (or other defective conditions) in an airframe without disassembly may help in the transition from programmed based maintenance (PBM) to condition based maintenance (CBM). CBM has the potential to reduce operations and support costs considerably.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a schematic view of an aircraft having a plurality of wireless sensor modules according to one embodiment of the present invention;

FIG. 2 is a block diagram of an exemplary wireless sensor module according to one embodiment of the present invention;

FIG. 3 is a block diagram of an exemplary central repository according to one embodiment of the present invention; and

FIG. 4 is a flowchart demonstrating one method of monitoring of a structure in accordance with one embodiment of the present invention.

### DETAILED DESCRIPTION OF EXAMPLE EMBODIMENTS OF THE INVENTION

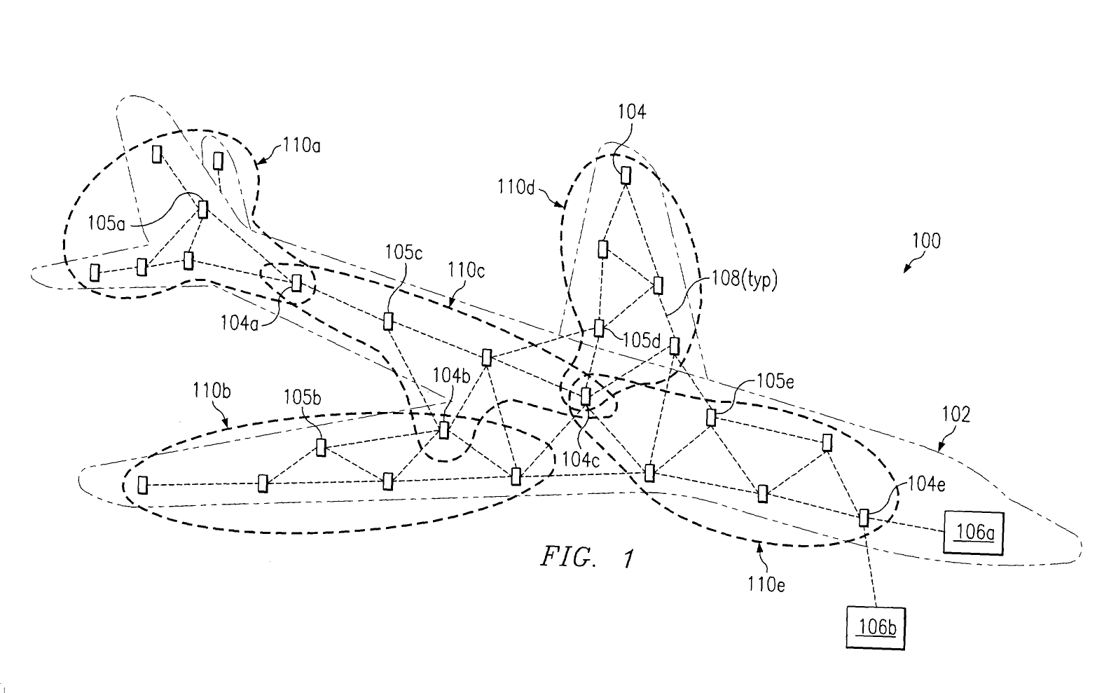

Example embodiments of the present invention and their advantages are best understood by referring now to FIGS. 1-4 of the drawings, in which like numerals refer to like parts.

FIG. 1 is a schematic view of a system 100 for monitoring a structure according to one embodiment of the present invention. In the illustrated embodiment, the structure that system 100 is monitoring is an aircraft 102. However, system 100 may monitor other structures, such as automobiles, ships, or other suitable structures in which structural health is desired to be monitored. System 100 includes a plurality of wireless sensor modules 104, 105 and a central repository 106. Generally, each sensor module 104, 105 transmits data representative of a sensed characteristic of aircraft 102 to one or more neighboring sensor modules 104, 105 via suitable wireless links 108. Eventually, one of the sensor modules (104e in the illustrated embodiment) transmits data representative of all sensed characteristics to central repository 106 so that the “structural health” data may be processed into usable information. This information may be assessed in real-time by a pilot or other personnel on aircraft 102 or may be downloaded at a later time by maintenance personnel inside a maintenance depot, for example.

System 100 avoids having to query each sensor module 104, 105 with a handheld RF interrogator and provides fault tolerant communication of data representative of sensed characteristics of aircraft 102 to central repository 106. One technical advantage of system 100 illustrated in FIG. 1 is that it may be easily incorporated into existing aircraft (or other suitable structures) and provide real-time assessment of structural health, such as corrosion, strain, vibration, g-forces, etc. As described further below, system 100 is low-cost, low-power and does not interfere with aircraft avionics.

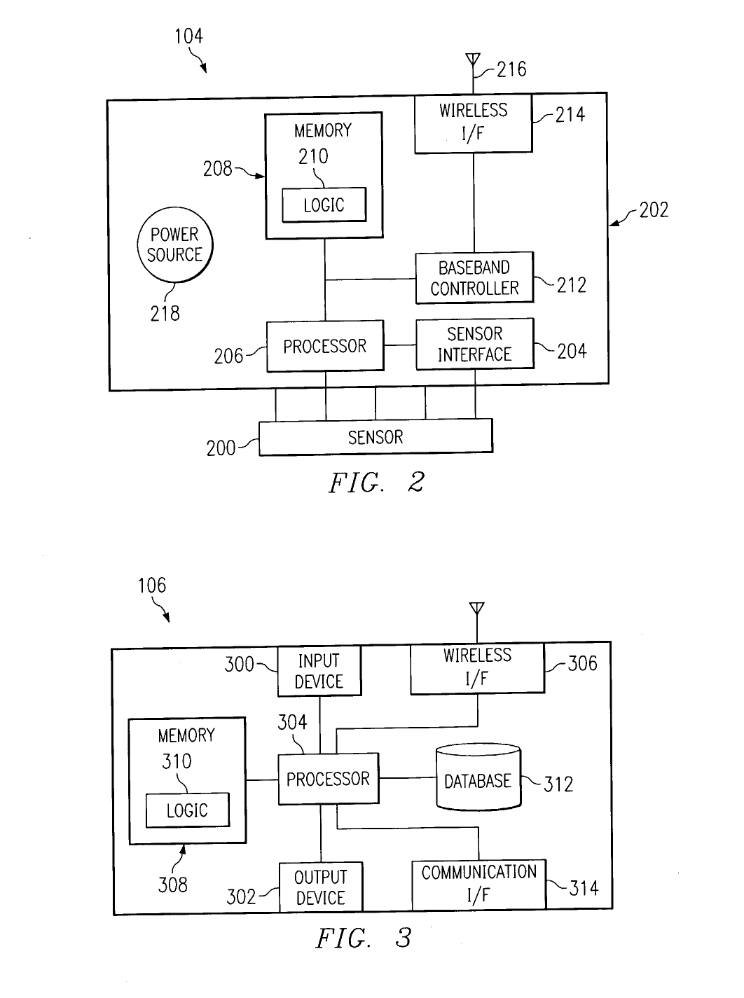

Sensor modules 104, 105, which are described in detail below in conjunction with FIG. 2, may be coupled to aircraft 102 in any suitable location. In addition, any number of sensor modules 104, 105 may be utilized. Typically, sensor modules 104, 105 are strategically placed throughout aircraft 102 in areas that are important for one to know of the structural health of that particular portion. For example, some areas of aircraft 102 may be particularly susceptible to corrosion. In this case, sensor modules 104, 105 may be concentrated in these areas. As described above, each sensor module 104, 105 generally functions to transmit data representative of a sensed characteristic of aircraft 102 to one or more neighboring sensor modules 104, 105 via suitable wireless links 108.

Central repository 106, which is described in detail below in conjunction with FIG. 3, may be located on aircraft 102, as depicted by reference numeral 106a, or may be located remote from aircraft 102, as depicted by reference numeral 106b. Generally, central repository 106 receives data from one of the sensor modules (104e in the illustrated embodiment) and processes this data into usable information regarding the structural health of aircraft 102.

Wireless links 108 may be based on any suitably established protocols, technologies or standards. For example, wireless links 108 may be RF links, infrared (IR) links, microwave links or other suitable wireless links. In a particular embodiment, wireless links 108 operate in the unlicensed, 2.4 gigahertz radio spectrum. As illustrated in FIG. 1 by lightly dashed lines, wireless links 108 may be seen to be going from one sensor module 104, 105 to more than one other sensor module 104, 105. This illustrates that, in one embodiment, data from one sensor module 104, 105 is being broadcast in such a manner that more than one other sensor module 104, 105 receives the data. Further details on how data travels between sensor modules 104, 105 before reaching central repository 106 is given below. A technical advantage of broadcasting the data is that it makes system 100 fault tolerant. In case one of the sensor modules 104, 105 fails, then data from that sensor module 104, 105 may be stored in, and retrieved from, another sensor module 104, 105.

FIG. 2 is a block diagram of an exemplary sensor module 104 according to one embodiment of the present invention. In the illustrated embodiment, sensor module 104 includes a sensor 200 coupled to a communication device 202. Sensor 200 may be coupled to communication device 202 in any suitable manner. Typically, sensor 200 is physically plugged into communication device 202 with a plurality of leads 201. Sensor 200 may be any suitable sensing device that is operable to sense a characteristic of aircraft 102. For example, characteristics sensed by sensor 200 may be corrosion, stress, strain, vibration, g-forces, defects, or other suitable characteristics of aircraft 102. Sensor 200, in addition to sensing the characteristic of aircraft 102, is operable to send a signal representative of the sensed characteristic to communication device 202.

Communication device 202, in the illustrated embodiment, includes a sensor interface 204, a processor 206, a memory 208 storing logic 210, a baseband controller 212, a wireless interface 214 having an antenna 216, and a power source 218; however, the present invention contemplates communication device 202 having more, less, or different elements than those illustrated.

Sensor interface 204 is any suitable device that receives a signal from sensor 200 that is indicative of a sensed characteristic of aircraft 102 and conditions that signal into a format that processor 206 may utilize. Sensor interface 204 may be, for example, an analog-to-digital converter.

Processor 206 comprises any suitable type of processing unit that executes logic 210 stored in memory 208. Processor 206 may be a reduced instruction set computer (RISC), a complex instruction set computer (CISC), and application specific integrated circuit (ASIC), a biological computer, an atomic computer, or any other type of device for manipulating information. One of the functions of processor 206 is to receive a signal that has been conditioned by sensor interface 204 that is representative of a characteristic of aircraft 102 and to store this data in memory 208. Another function of processor 206 is to facilitate the transmitting and receiving of data to and from neighboring sensor modules 104, 105 via baseband controller 212 and wireless interface 214, and to facilitate the storing of received data in memory 208.

Memory 208 may comprise files, stacks, databases, or other suitable organizations of volatile or non-volatile memory. Memory 208 may be random access memory, read only memory, removable memory devices, or any other suitable device that allows storage and/or retrieval of data. Logic 210 may be any suitable computer program written in any suitable computer language that is operable, in one embodiment, to initiate communications with other communication devices 202 associated with neighboring sensor modules 104, 105, organize the storage of data in memory 208, or control the sensing characteristics of aircraft 102 by sensor 200. Logic 210 may have other suitable functions.

Baseband controller 212 functions to convert signals received by wireless interface 214 from the format used for wireless links 108 to an appropriate one for processor 206, such as by determining data based on a modulation sequence. Baseband controller 212 may also perform additional processing on the signal received, such as error correction, security validation, and delivery assurance. Some of these functions may also be performed by processor 206 either alone or in conjunction with baseband controller 212. Baseband controller 212 may handle other aspects of wireless link 108, such as channel hopping. For example, in an embodiment where communication device 202 is Bluetooth™ enabled, baseband controller 212 typically implements certain layers of a Bluetooth™ stack, such as logical link control and adaptation protocol (L2CAP) or host controller interface (HCI). Baseband controller 212 may perform similar formations for transmission operations. The data may then be sent to, or retrieved by, communication device 202 through wireless interface 214.

Wireless interface 214 may be any suitable device that supports wireless communications between communication devices 202 of sensor modules 104, 105. For example, wireless interface 214 may be a transceiver, a wireless modem, or other suitable wireless interface. Wireless interface 214 may be associated with communication device 202 in any suitable manner. In addition, wireless interface 214 may have an associated antenna 216, which may be any suitable antenna, that is operable to receive and broadcast signals between communication devices 202 and direct them to wireless interface 214. Wireless interface 214 may then condition the signals before directing them to baseband controller 212. For example, wireless interface 214 may remove a carrier frequency from a received signal. Baseband controller 212 is then operable to convert the signal into a format that is acceptable for storage in memory 208 by processor 206. The stored data may then be processed in any suitable manner using logic 210. Conversely, when data is to be transmitted from communication device 202 to neighboring communication devices 202, processor 206 converts the data stored in memory 208 into an appropriate format for baseband controller 212. For example, processor 206 may generate an indicator to combine with the data so that a receiving communication device 202 knows which sensor module 104 transmitted the data. Baseband controller 212 then converts the data into the appropriate format for wireless transmission, such as by determining a modulation sequence based on the data. Based on the converted data, wireless interface 214 transmits signals representing the data using antenna 216, such as by inserting the data onto a carrier frequency.

Power source 218 may be any suitable power source, such as a battery, that provides power to communication device 202. Power source 218 may be coupled to communication device 202 in any suitable manner.

Referring back to FIG. 1, in an embodiment of the present invention where communication devices 202 are Bluetooth™ enabled, system 100 may comprise a plurality of piconets 110 (represented by heavy dashed lines) that together make up a scatternet. A “piconet” may be defined as a network of wireless devices connected in an ad hoc fashion using Bluetooth™. Each piconet includes one master sensor module 105 and from one to seven slave sensor modules 104. A “scattemet” may be defined as a group of independent an non-synchronized piconets that share at least one common Bluetooth™ device.

In operation of the illustrated embodiment, a master sensor module 105 associated with a respective piconet 110 controls the flow of data between all of the sensor modules (including itself) in that respective piconet 110. More specifically, master sensor module 105 directs each slave sensor module 104 in its associated piconet 110 to transmit data representative of the characteristic of aircraft 102 that it has sensed to all other sensor modules 104, 105 in that respective piconet 110. Master sensor module 105 also transmits data that it has sensed to all of the slave sensor modules 104. In this way, each sensor module 104, 105 in a particular piconet 110 has data stored therein that is representative of all of the sensed characteristics for that piconet 110.

Thus, master sensor module 105a controls the flow of data between all of the slave sensor modules 104 and itself in piconet 110a, master sensor module 105b controls the flow of data between all of the slave sensor modules 104 and itself in piconet 110b, master sensor module 105c controls the flow of data between all of the slave sensor modules 104 and itself in piconet 110c, master sensor module 105d controls the flow of data between all of the slave sensor modules 104 and itself in piconet 110d, and master sensor module 105e controls the flow of data between all of the slave sensor modules 104 and itself in piconet 110e.

To facilitate the transmitting of all this data to central repository 106, piconet 110e includes one sensor module 104e that functions to transmit data representative of each sensed characteristic of all of aircraft 102 to central repository 106. Sensor module 104e is able to receive this data because there is at least one sensor module (either slave or master) in each piconet 110 that can be part of another piconet. For example, a slave sensor module 104a associated with piconet 110a may also be part of piconet 110c, as illustrated by the heavy dashed lines that define piconets 110a and 110c. Accordingly, at the appropriate time, master sensor module 105c of piconet 110c directs each of the slave sensor modules 104 in piconet 110c, which includes slave sensor module 104a, to transmit data representative of sensed characteristics of aircraft 102 that it has stored therein to all other sensor modules 104, 105 in that respective piconet 110. Because slave sensor module 104a has data stored therein that is representative of all of the sensed characteristics for piconet 110a, then all sensor modules 104, 105 within piconet 110c will now have that data in addition to all of the data that is representative of all of the sensed characteristics for piconet 110c.

Similarly, slave sensor module 104b of piconet 110b and slave sensor module 104c of piconet 110d may also be part of piconet 110c and, therefore, be able to transmit data representative of sensed characteristics of aircraft 102 sensed by sensor modules 104, 105 of its respective piconet 110 to all other sensor modules 104, 105 in piconet 110c. Slave sensor module 104c may, in turn, be associated with piconet 110c and be able to transmit data representative of sensed characteristics of aircraft 102 sensed by sensor modules 104, 105 of piconets 110a, 110b, 110c, and 110d to piconet 110e. Since slave sensor module 104e, now is able to obtain data representative of all sensed characteristics of aircraft 102 sensed by all sensor modules 104, 105, then slave sensor module 104e may transmit this data to central repository 106.

FIG. 3 is a block diagram of an exemplary central repository 106 according to one embodiment of the present invention. As illustrated, central repository 106 includes an input device 300, an output device 302, a processor 304, a wireless interface 306, a memory 308 storing logic 310, and a database 312. Central repository 106 may also include a communications interface 314.

Input device 300 is coupled to central repository 106 for the purpose of inputting information, such as how to process or display data stored therein. In one embodiment, input device 300 is a keyboard; however, input device 402 may take other suitable forms, such as a keypad, a mouse, or a stylus. Output device 302 may be any suitable visual display unit, such as an LCD or CRT display. Output device 302 may also be coupled to a printing device (not shown) for the purpose of printing out any desired information, such as data related to the structural health of aircraft 102.

Processor 304 comprises any suitable type of processing unit that executes logic. For example, processor 304 may be a RISC, a CISC, an ASIC, a biological computer, an atomic computer, or any other type of device for manipulating information. One of the functions of processor 304 is to control the storing of received data in memory 308. In addition, processor 304 may function to query one or more sensor modules 104, 105 to receive the data. Processor 304 may have other suitable functions, such as controlling the transmitting of data stored in memory 308 via either wireless interface 306 or communications interface 314.

Logic 310 is a computer program written in any suitable computer language that is operable, in one embodiment, to process data representative of sensed characteristics of aircraft 102. For example, logic 310 may be operable to organize the data in a usable manner. In other words, logic 310 may be able to manipulate the data stored in memory 308 into graphs, charts, or other suitable outputs that show a maintenance personnel or pilot of aircraft 102 that a particular area of aircraft 102 is corroding at a very rapid pace. As a result, maintenance personnel may be able to address this concern by repairing this part of aircraft 102 in a cost-efficient manner.

Memory 308 and database 312 may comprise files, stacks, databases, or other suitable organizations of volatile or non-volatile memory. Memory 308 and database 312 may be random access memory, read only memory, CD-ROM, removable memory devices, or any other suitable devices that allow storage and/or retrieval of data. Memory 308 and database 312 are interchangeable and may perform the same function.

Wireless interface 306 is any suitable device that supports wireless communications between central repository 106 and sensor modules 104, 105. In an embodiment where central repository 106 is remote from aircraft 102, wireless interface 306 may support wireless communications between central repository 106 and sensor modules 104,105 on aircraft 102 via suitable wireless communication devices associated with any suitable wireless network (not shown), such as base transceiver stations or wireless access points. As examples, wireless interface 306 may be a transceiver, a wireless modem, or other suitable wireless interface. Wireless interface 306 may also have an associated antenna 307 for transmitting and receiving signals wirelessly.

Communications interface 314 functions to communicate with any suitable communications network (not shown). For example, data stored in memory 308 may wish to be transmitted from central repository 106 to some other location. In this case, communications interface 314 facilitates this transmission. In one embodiment, communications interface 314 is a network interface card; however, communications interface 314 may be other devices suitable for receiving and transmitting signals, such as a modem.

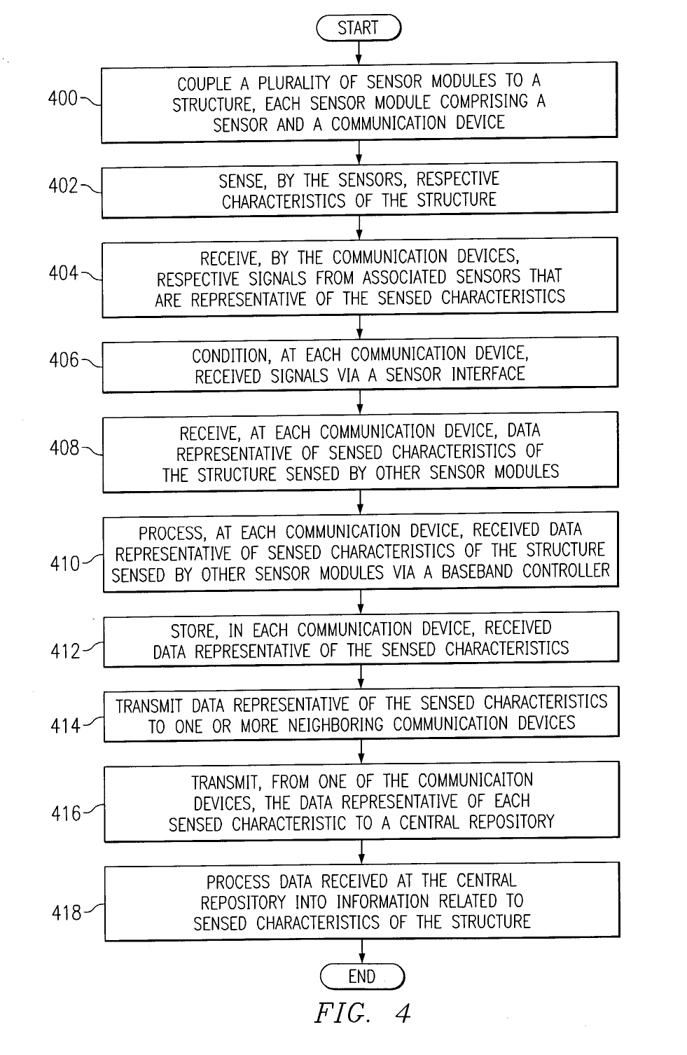

FIG. 4 is a flowchart demonstrating an exemplary method of monitoring a structure in accordance with one embodiment of the present invention. The example method begins at step 400, in which a plurality of sensor modules 104, 105 are coupled to a structure, such as aircraft 102. Each sensor module 104, 105 comprises a sensor, such as sensor 200 and a communication device, such as communication device 202. Sensor 200 and communication device 202 may be coupled to each other in any suitable manner and may be coupled to aircraft 102 in any suitable manner and in any suitable location. Respective characteristics of aircraft 102 are sensed by sensors 200 at step 402. For example, sensors 200 may sense corrosion, stress, strain, vibration, g-forces, or other suitable characteristics of aircraft 102 for the purpose of monitoring its structural health. At step 404, communication devices 202 receive respective signals from associated sensors 200 that are representative of the sensed characteristic. These received signals are conditioned, at step 406, via sensor interface 204, for example. Sensor interface 204 may be an analog-to-digital converter that needs to convert an analog signal to a digital signal for processing by processor 206. The conditioned signals are stored as data in memory 208.

At step 408, each communication device 202 receives data representative of characteristics of the structure sensed by other sensor modules 104, 105. The received data is processed by communication devices 202 at step 410. For example, baseband controller 212 may receive signals via wireless interface 214 and condition them in a manner usable by processor 206. The received data is stored in memory 208 by each communication device 202 at step 412. The stored data may or may not be representative of all other sensor modules 104, 105. In other words, a particular communication device 202 may store data related to sensed characteristics by some sensor modules 104, 105 but not all sensor modules 104, 105. This is because, in one embodiment, the data is broadcast via a spread spectrum modulation technique. In this manner, more than one sensor module 104, 105 may receive the same data.

Data representative of sensed characteristics of aircraft 102 is transmitted, at step 414, to one or more communication devices 202. A spread spectrum modulation technique may be used by all sensor modules 104, 105 to transmit the data that is representative of the characteristic of the structure that it itself has sensed. In other words, the data is broadcast via data packets so that other sensor modules 104, 105 may receive this data and store it in its memory 208. Eventually, the data makes its way to a particular sensor module 104, 105 for transmission to central repository 106. This step is outlined in step 416 where sensor module 104a (FIG. 1) transmits the data representative of each sensed characteristics to central repository 106. At central repository 106, the data is processed, at step 418, into information related to sensed characteristics of the structure so that a user may utilize this information for structural health monitoring of aircraft 102.

Although embodiments of the invention and their advantages are described in detail, a person skilled in the art could make various alterations, additions, and omissions without departing from the spirit and scope of the present invention as defined by the appended claims.

What is claimed is:

1. A system for monitoring a structure, comprising:
a plurality of sensor modules coupled to the structure, each sensor module comprising:
a sensor operable to sense a characteristic of the structure; and
a communication device coupled to the sensor, the communication device operable to receive a signal from the sensor representative of the sensed characteristic and to transmit data representative of the sensed characteristic to one or more neighboring communication devices; and
a central repository operable to receive, from one of the communication devices, the data representative of each sensed characteristic.

2. The system of claim 1, wherein each communication device comprises:
a transceiver operable to transmit data to, and receive data from, the one or more neighboring communication devices;
a baseband controller operable to process received data;
a sensor interface coupled to the sensor, the sensor interface operable to condition the signal from the sensor;
a memory coupled to the baseband controller, the memory operable to store data; and
a processor coupled to the baseband controller, the memory, and the sensor interface, the processor operable to facilitate the transmitting and receiving of data and to facilitate the storing of data in the memory.

3. The system of claim 2, wherein the processor is further operable to generate an identifier for its associated sensor and to include this identifier in the data representative of the sensed characteristic.

4. The system of claim 2, wherein the communication device is Bluetooth™ enabled.

5. The system of claim 4, wherein the sensor modules comprise a piconet.

6. The system of claim 4, wherein the sensor modules comprise a scatternet.

7. The system of claim 4, wherein the received data include data regarding a characteristic of the structure sensed by a sensor beyond a broadcast range of the transceiver receiving the received data.

8. The system of claim 1, wherein the respective characteristic is selected from the group consisting of corrosion, stress, strain, vibration, g-force, and a crack.

9. The system of claim 1, wherein the central repository comprises a processor operable to process data into information related to sensed characteristics of the structure.

10. The system of claim 9, wherein the data is processed in real-time.

11. The system of claim 9, wherein the processor is further operable to query the one of the communication devices in order to receive the data representative of each sensed characteristic.

12. The system of claim 1, wherein the central repository is coupled to the structure.

13. The system of claim 1, wherein the central repository is remote from the structure.

14. A method for monitoring a structure, comprising:
coupling a plurality of sensor modules to the structure, each sensor module comprising a sensor and a communication device;
sensing, by the sensors, respective characteristics of the structure;
receiving, by the communication devices, respective signals from associated sensors that are representative of the sensed characteristics;
transmitting data representative of the sensed characteristics to one or more neighboring communication devices; and
transmitting, from one of the communication devices, the data representative of each sensed characteristic to a central repository.

15. The method of claim 14, further comprising:
conditioning, at each communication device, the received signal via a sensor interface;
receiving, at each communication device, data representative of sensed characteristics of the structure sensed by other sensor modules;
processing, at each communication device, the received data via a baseband controller;
storing, in each communication device, the data representative of the sensed characteristics; and
facilitating, at each communication device, the transmitting, receiving, and storing of data via a processor.

16. The method of claim 15, further comprising generating, at each communication device, an identifier for an associated sensor and including this identifier in the data representative of a respective sensed characteristic.

17. The method of claim 15, further comprising enabling the communication device with Bluetooth™.

18. The method of claim 14, wherein the respective characteristic is selected from the group consisting of corrosion, stress, strain, vibration, g-force, and a crack.

19. The method of claim 14, further comprising processing data received at the central repository into information related to sensed characteristics of the structure.

20. The method of claim 19, wherein the processing is carried out in real-time.

21. The method of claim 14, further comprising querying the one of the communication devices in order to receive the data representative of each sensed characteristic.

22. The method of claim 14, further comprising coupling the central repository to the structure.

23. The method of claim 14, further comprising locating the central repository remote from the structure.

24. A system for monitoring a structure, comprising:
a plurality of piconets, each piconet having one master sensor module and one or more slave sensor modules coupled to the structure;
each sensor module comprising:
a sensor operable to sense a characteristic of the structure; and
a communication device coupled to the sensor, each communication device comprising:
a sensor interface coupled to the sensor, the sensor interface operable to receive a signal from the sensor and condition the signal, the signal representative of the characteristic sensed by the sensor;
a processor coupled to the sensor interface, the processor operable to store the signal in a memory;
a transceiver operable to broadcast data representative of stored signals to neighboring communication devices, the transceiver further operable to receive, from the neighboring communication devices, data representative of signals associated with characteristics of the structure sensed by the neighboring communication devices; and
a baseband controller operable to process received data; and
a central repository operable to receive, from one of the master sensor modules of the plurality of piconets, the data representative of each sensed characteristic of the structure.

25. The system of claim 24, wherein the processor is further operable to generate an identifier for its associated sensor and to include this identifier in the data representative of the sensed characteristic.

26. The system of claim 24, wherein the respective characteristic is selected from the group consisting of corrosion, stress, strain, vibration, g-force, and a crack.

27. The system of claim 24, wherein the central repository includes a processor operable to process data into information related to sensed characteristics of the structure.

28. The system of claim 27, wherein the data is processed in real-time.

29. The system of claim 27, wherein the processor is further operable to query the one of the master sensor modules in order to receive the data representative of each sensed characteristic of the structure.

30. The system of claim 24, wherein the central repository is coupled to the structure.

31. The system of claim 24, wherein the central repository is remote from the structure.
